(19) United States
(12) Patent Application Publication
(10) Pub. No.: US 2003/0143878 A1
(43) Pub. Date: Jul. 31, 2003

(54) CONNECTOR FIXTURE

(76) Inventors: Kuo-Chin Huang, Hsinchu City (TW); Jong-Wen Gea, Hsinchu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,440

(22) Filed: Jan. 21, 2003

(30) Foreign Application Priority Data
Jan. 25, 2002 (TW) 091200943

(51) Int. Cl. H01R 4/66

(52) U.S. Cl. 439/100

(57) ABSTRACT

A connecting slot of appropriate size is punched for receiving a connector in the upper casing of a motherboard module of the present invention; the connector is soldered to the motherboard by a base; a screw hole is disposed each on both ends of the base; a mounting plate is extended each from both ends of the connecting slot of the metal upper casing into the connecting slot, and the end is bent and attached the upper surface of screw holes on both ends of the base and forms a hole relate to the screw hole; a bolt is passed through the hole and secured into the screw hole, and the mounting plate is tightly pressed and secured to the base to electrically ground the connector with the casing in order to provide the grounding for eliminating electromagnetic interference and fit various connectors and enhance the securing effect.

### BACKGROUND OF INVENTION

1. Field of Invention

The present invention relates to a connector fixture, and more particularly, to a connector fixture capable of eliminating the electromagnetic interference.

2. Background of the Invention

In recent years, electronic information industry is blooming and various applications of electronic information products become more popular day after day. Since the size of electronic information products tends to be smaller and smaller, the intermittent or continuous voltage of the internal system changes rapidly, and produces a great deal of noises that seriously affects the functions of each device. Such phenomenon is generally called electromagnetic interference (EMI). EMI generally enters or exits a circuit in two ways: radiation and conduction, of which radiation is leaked from the gap, groove, or other opening of the casing, and conduction is transmitted to power supply, signal, or control line to generate interference. Therefore, it is an important research and development subject in the industry on how to suppress electromagnetic interference and ensure that electronic and electric products can be operated in an appropriate electromagnetic environment.

In general, conventional electric appliances usually adopt metal casing for holding a circuit under electric field of high frequencies. Besides the necessary equipment transportation process, manufacturing, ventilation, external monitoring window, panel connection, and assembly accessories require to have openings on the external casing, the circuit is almost completely isolated from the outside to shelter its sensitive parts, which can reinforce the shielding of electromagnetic interference (EMI) and prevent noises to the circuit generated by the radiation of high-frequency signals. The EMI will affect the normal operation of the electric appliance. In addition, the suppression of the EMI produced by the conductive cables of the prior-art device is shown in FIGS. 1 and 2. These figures illustrate the R.O.C. Patent No. 88209351, and the patented invention comprises: a connector 10; a plurality of conductive terminals 121 being folded and extended towards the interior of an insulating member 11, protruding from a connecting surface and being coupled to a motherboard 16; a casing 12, wrapping a conductive terminal 121 and protruding from the connecting surface of the insulating member 11; a grounding device 14 at its center having a penetrating hole for being sheathed into the metal casing 12, and both sides of the grounding device 14 having a bent contact plate 141, a hole 13 is disposed each on both ends of the grounding device 14 for passing a rivet 17 to couple the insulating member 11,the metal casing 12, and the grounding device 14 to constitute the connector 10. A fixing pin 15 is protruded from both ends of the connecting surface of the insulating member 11 to secure the connector 10 to the motherboard 16. When the motherboard 16 of the patented invention is installed into the computer system for use, the motherboard 16 is installed onto the bent contact plate 141 of the insulating member 11 to keep contact with the casing 18 of the computer system and electrically connected to the grounding circuit in order to attain the purpose of eliminating electromagnetic interference.

However, since the contact plate 141 of the previously disclosed prior art utilizes the elasticity of the lifted contact plate 141 to press the contact plate 141 tightly to keep the contact plate 141 in contact with the casing 18 of the system. The contact may be in the form of a point contact or a line contact. Due to the manufacturing tolerance of the end of the contact plate 141 and the casing 18 of the system, the contact plate 141 and the casing 18 cannot be kept in a close contact in a gap, and the gap so formed will lower the effect of eliminating electromagnetic interference. In addition, if the connector without such grounding measure is adopted, then the connector will not have the effect of eliminating electromagnetic interference. Obviously, the prior-art device is not applicable for the flexibility of adapting various connectors, and thus will increase the manufacturing cost of the product.

### SUMMARY OF INVENTION

The objective of the present invention is to provide a connector fixture that utilizes the surface contact for grounding to enhance the effect of eliminating the electromagnetic interference.

The secondary objective of the present invention is to provide a connector fixture for adapting various connectors to ensure the manufacturing flexibility and reduce the cost of the product.

Another objective of the present invention is to provide a connector fixture to reinforce the fixture of the connector, such that the connector will not be loosened easily to raise the life of the product.

To accomplish the above objectives, a connecting slot of appropriate size is punching for receiving a connector in the upper casing of a motherboard module of the present invention; the connector is soldered to the motherboard by a base; a screw hole is disposed each on both ends of the base; a mounting plate is extended each from both ends of the connecting slot of the metal upper casing into the connecting slot, and the end is bent and attached onto the upper surface of screw holes on both ends of the base and forms a hole relate to the screw hole; a bolt is passed through the hole and secured into the screw hole, and the mounting plate is tightly pressed and secured to the base to electrically ground the connector with the casing in order to provide the grounding for eliminating electromagnetic interference.

### BRIEF DESCRIPTION OF DRAWINGS

FIG. 1 is a diagram of the perspective view of the prior-art connector disclosed in the R.O.C. Patent Application No. 88209351.

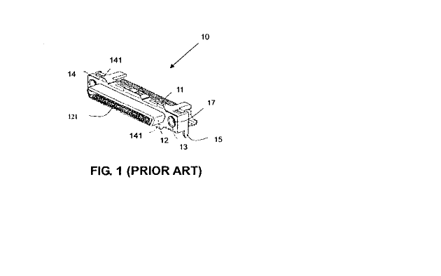

FIG. 2 is a side cross-sectional view of the connector of the Patent as illustrated in FIG. 1.

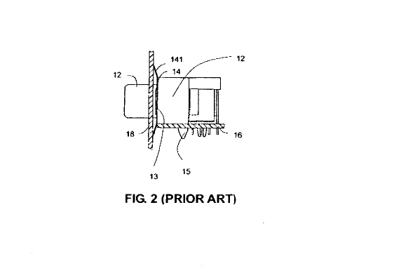

FIG. 3 is a perspective view of the motherboard module of the present invention.

FIG. 4 is a side cross-sectional view of the connector of the present invention.

FIG. 5 is a perspective view of the connector fixture of the present invention.

### DETAILED DESCRIPTION

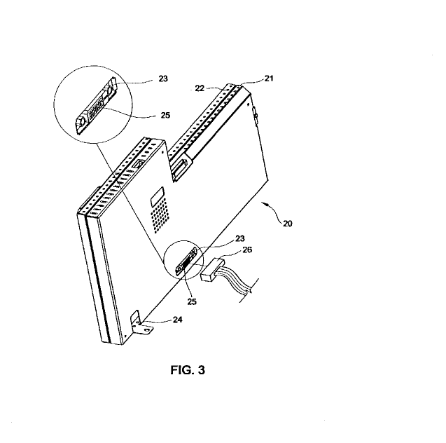

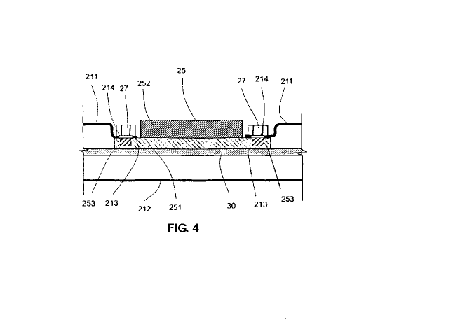

Please refer to FIG. 3 and FIG. 4 for a preferred embodiment of the present invention. In the figure, the motherboard module 20 having a motherboard 30 being enclosed by a casing 21 comprises a metal upper casing 211 and a metal lower casing 212. Besides the necessary heat-diffusing hole 22, the connecting slot 23 and the fixing hole 24, the motherboard 30 is almost completely isolated from the outside to reinforce the shielding of electromagnetic interference (EMI) and prevent the production of noises.

Wherein a connecting slot 23 of appropriate size is punched from the upper casing 211 of the motherboard module 20 such that the connecting slot 23 can exactly receive a connector 25, and the connector 25 is soldered to the motherboard 30 with a base 251 and secured to the motherboard 30 in the position relative to the connecting slot 23; a connecting section 252 is disposed at the center of the base 251 with its upper end slightly protruded from the upper casing 211 to facilitate the connection of a flat cable plug 26 to the motherboard module 20 for transmitting signal; furthermore, the base 251 at both of its ends each forming a screw hole 253; the metal upper casing 211 is connected to both ends of the connecting slot 23, and a mounting plate 213 is extended from each end and extended inside the connecting slot 23; the end of the connecting slot 23 is bent and attached onto the surface of screw holes 253 on both ends of the base 251 and forms a hole 214 relating to the screw hole 253; a bolt 27 is passed through the hole 214 and secured into the screw hole 253, and the mounting plate 213 is tightly pressed and secured to the upper surface of the base 251 to electrically ground the connector 25 with the casing 21.

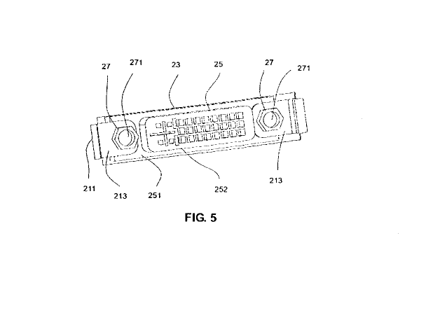

In FIG. 5, the connector fixture of the present invention is integrally punched from both ends of the connecting slot 23 on the upper casing 211 of the motherboard module 20 to form the mounting plates 213 during manufacturing and punching the connecting slot 23, so that one end of the mounting plate 213 attaches onto the upper surface on both ends of the base 251, and the base 251 is soldered onto the motherboard 30. By means of securing the bolt 27 at its center having a connecting screw hole 271 into the screw hole 253, the mounting plate 213 and the connector 25 constitute a grounding connection in the form of surface contact.

Since the mounting plate 213 attaches onto the surface of the base 251 of the connector 25 by the bolt 27, it gives a good contact surface and generates a high electric conductivity. Thus, when the flat cable plug 26 is plugged into the connecting section 252 and secured into the connecting screw hole 271, the electromagnetic interference produced by the transmitting signal can be grounded and eliminated quickly by the surface contact with a higher conductivity. In addition, the mounting plate 213 for grounding connection is punched integrally from both ends of the connecting slot 23 of the casing 21 of the motherboard module 20 during the punching, and is attached and coupled onto the connector 25. The fixing by the bolt 27 and the connector 25 not only simplifies the components of the grounding device of the connector 25 and reduces the material and manufacturing costs, but also fits for various connectors without a grounding device to improve the manufacturing flexibility of the component design and product manufacturing. Furthermore, the mounting plate 213 of the present invention is extended from a rigid metal casing 21 and fixed to both ends of the connector 25 to provide a secure fixing to the connector 25. Such arrangement can avoid the shortcomings of the traditional connector that only solders the terminal or embeds the connector into the motherboard; after many times of plugging and unplugging the connector, the connector will be loosened and cause bad contact, and further affects the electric connection.

Similarly, the mounting plate 213 of the present invention also is connected or extended to other peripheries of the connecting slots 23, and fixed onto the connector 25 to obtain the same grounding effect for eliminating the electromagnetic interference.

What is claimed is:

1. A connector fixture, comprising:
a casing;
a connecting slot, disposed on a hole on the casing;
a connector, disposed inside the connecting slot; and
at least one mounting plate, coupled to an opening edge of the connecting slot and extending to fix the connector.

2. The connector fixture of claim 1, wherein the mounting plate is extended integrally from the casing.

3. The connector fixture of claim 1, wherein the mounting plate comprises an end being attached and secured onto the connector.

4. The connector fixture of claim 3, wherein the end comprises a hole for securing the connector with a bolt.

5. The connector fixture of claim 4, wherein the mounting plate being extended each from both ends of the connecting slot.

6. The connector fixture of claim 5, wherein the bolt at its center comprises a connecting screw hole.

7. The connector fixture of claim 1, wherein the casing is made of metal.
